(19) United States
(12) Patent Application Publication
(10) Pub. No.: US 2026/0064476 A1
(43) Pub. Date: Mar. 5, 2026

(54) MANAGING ACCELERATOR RESOURCES OF A COMPUTER SYSTEM

(71) Applicant: Hewlett Packard Enterprise Development LP, Spring, TX (US)

(72) Inventors: Gernot Seidler, San Jose, CA (US); Lalit Somavarapha, San Jose, CA (US); Swami Viswanathan, Morgan Hill, CA (US); Srujana Reddy Attunuri, San Jose, CA (US)

(21) Appl. No.: 18/824,052

(22) Filed: Sep. 4, 2024

(51) Int. Cl. G06F 9/50

(52) U.S. Cl. CPC G06F 9/5038; G06F 9/5044; G06F 9/505; G06F 2209/5021; G06F 2209/5022; G06F 2209/503

(57) ABSTRACT

In certain implementations, computer-implemented method includes monitoring use of a first accelerator resource allocated to a first computing workload and determining, based on monitoring the use of the first accelerator resource allocated to the first computing workload, that the use of the first accelerator resource allocated to the first computing workload satisfies an idleness condition. The method further includes reallocating, based at least on determining that the use of the first accelerator resource allocated to the first computing workload satisfies the idleness condition, the first accelerator resource to a second computing workload, the second computing workload being a pending computing workload.

### BACKGROUND

Some computing environments may use one or more accelerators to execute computing tasks more efficiently. For example, a central processing unit (CPU) may offload or otherwise assign certain tasks to one or more accelerators for execution. As another example, a management computing node may assign processing tasks to accelerators in cluster. Example accelerators may include graphics processing unit (GPU) devices, application-specific integrated circuit (ASIC) devices, field-programmable gate array (FPGA) devices, and vision processing unit (VPU) devices, and/or other types of devices. Although potentially used for any of a variety of purposes, computer systems may use these accelerators to accelerate execution of computationally-intensive algorithms, such as artificial intelligence processing, machine learning algorithms, or genome sequence alignment algorithms.

### BRIEF DESCRIPTION OF THE DRAWINGS

For a more complete understanding of this disclosure, and advantages thereof, reference is now made to the following descriptions taken in conjunction with the accompanying drawings, in which:

FIG. 1 illustrates an example computing system for managing accelerator resources, according to certain implementations;

FIG. 2 illustrates additional details of a scheduler node, according to certain implementations;

FIG. 3 illustrates an example scheduler, according to certain implementations;

FIG. 4 illustrates an example scheduler, according to certain implementations;

FIG. 5 illustrates additional details of an example of workload queue of FIG. 2, according to certain implementations;

FIG. 6 illustrates an example of workload information table, which may include and/or be part of workload information of FIG. 1, according to certain implementations;

FIG. 7 illustrates an example user interface, according to certain implementations;

FIG. 8 illustrates an example method for managing accelerator resources, according to certain implementations;

FIG. 9 illustrates an example method for managing accelerator resources, according to certain implementations;

FIG. 10 illustrates an example method for determining whether to reclaim accelerator resources that have been allocated to a particular workload, according to certain implementations; and

FIG. 11 illustrates a block diagram of an example computing device, according to certain implementations.

### DESCRIPTION

GPUs and other accelerators may be in-demand computing resources that typically are expensive and therefore potentially scarce. Managing the use of accelerator resources presents certain challenges. In certain computing environments, a scheduler may be aware of computing workloads, and may allocate accelerator resources to computing workloads. For example, a scheduler of a containerization environment may receive computing workloads. Those computing workloads could be JUPYTER NOTEBOOKS or another interactive application; however, this disclosure contemplates any suitable type of computing workloads that could be processed using a containerization environment or other computing environment. The scheduler may allocate one or more accelerator resources to the computing workload to execute the computing workload. For example, the scheduler may allocate certain GPU resources (e.g., one or more GPUs or one or more portions of one or more GPUs) to the computing workload for execution of the computing workload.

Whether in a containerization computing environment or another type of computing environment, allocating an accelerator resource to a computing workload may mean the computing workload has exclusive use of the accelerator resource for a specific time period, until the computing workload terminates, and/or until another suitable event occurs. As a result, if the computing workload is idle, the accelerator resource(s) allocated to that computing workload also is idle. This is inefficient, particularly if other computing workloads are pending, waiting for accelerator resources to become available, as the workload to which the accelerator resource is allocated is allowing the accelerator resource to sit idle, monopolizing the accelerator resource while other computing workloads wait in a pending workload queue, leading to underutilization of the accelerator resource.

Certain implementations of this disclosure provide techniques for automatic resource reclamation of idle accelerator resources (e.g., GPU). In certain implementations, a scheduler, which may be implemented as a standalone scheduler or a plugin to another scheduler, may monitor use of accelerator resources allocated to computing workloads. For example, the accelerator resources may report usage information and/or the workloads themselves may include certain information (e.g., priority information, utilization thresholds, and/or any other suitable information). The scheduler may determine, based on monitoring the use of the accelerator resources, that the use of a particular accelerator resource satisfies an idleness condition. The idleness condition may be implemented as an idleness threshold, and determining that the use of the particular accelerator resource satisfies the idleness condition may include determining that the use of the particular accelerator resource does not meet (e.g., is less than, or is less than or equal to, depending on the implementation) the idleness threshold. As a particular example, the usage information may include accelerator resource usage information (e.g., utilization metrics), and determining whether the use of the particular accelerator resource satisfies the idleness condition may include determining whether the average accelerator resource usage over a particular time period (e.g., as determined from the utilization metrics) satisfies an idleness threshold for average accelerate resource usage over the particular time period. Certain implementations may provide a toleration time period that defines a delay before a computing workload that has been allocated an accelerator resource will be evaluated for idleness, to allow the workload to start up and initialize before beginning to use the accelerator resource.

Based at least on determining that the use of a particular accelerator resource satisfies the idleness condition, the scheduler may deallocate the particular accelerator resource from the particular computing workload, thereby reclaiming the particular accelerator resource, and reallocate the particular accelerator resource to a pending computing workload that is awaiting an accelerator resource. In some implementations, multiple computing workloads may be pending (e.g., in a pending workloads queue), and the scheduler may consider relative priorities among the pending computing workloads when determining the pending workload to which the scheduler will reallocate the reclaimed accelerator resource. The priorities could be specified in workload information that accompanies the workloads (e.g., in container metadata, such as annotations, of a container). In certain implementations, priorities could correspond to groups of computing workloads, such as workload types, project type, department associated with the computing workload, and any other suitable grouping criteria.

Certain implementations may run this reclamation process substantially continuously or on another suitable regular or irregular time interval or in response to particular types of events (e.g., receipt by the scheduler of a new computing workload). As just one example, the scheduler could run the reclamation process as a cron job that is scheduled to run at a suitable time interval (e.g., every five to seven minutes or another suitable time interval).

The particular computing workload from which the accelerator resource was deallocated can be handled in any suitable manner. In certain implementations, the particular computing workload from which the accelerator resource was taken may be placed in a pending workload queue, eligible to be assigned accelerator resources along with other pending computing workloads according to applicable scheduling policies. This approach may be referred to as non-destructive preemption, as this approach moves computing workloads from which accelerator resources have been reclaimed to a pending state rather than terminating those computing workloads. Of course, this disclosure contemplates simply terminating those computing workloads, if appropriate.

Certain implementations provide flexible configuration options for administrators to set idleness conditions (e.g., idleness thresholds)/usage thresholds, priorities, time periods, and toleration time periods. Certain implementations provide support for both physical and virtual accelerators (e.g., pGPUs and vGPUs).

Certain implementations may be used with containerization environments (e.g., KUBERNETES clusters), virtualized environments, high performance computing (HPC) environments, or other suitable computing environments to efficiently allocate and manage the accelerator resources for processing computing workloads within these computing environments. For example, computing workloads in containerization environments, such as in a KUBERNETES environment that uses clusters, may include a built-in scheduler. As described above, certain implementations integrate with existing containerization platforms (e.g., KUBERNETES components) and can be deployed alongside the default scheduler (e.g., as a scheduler plugin), allowing for granular control over accelerator-specific computing workload management without affecting other resource types.

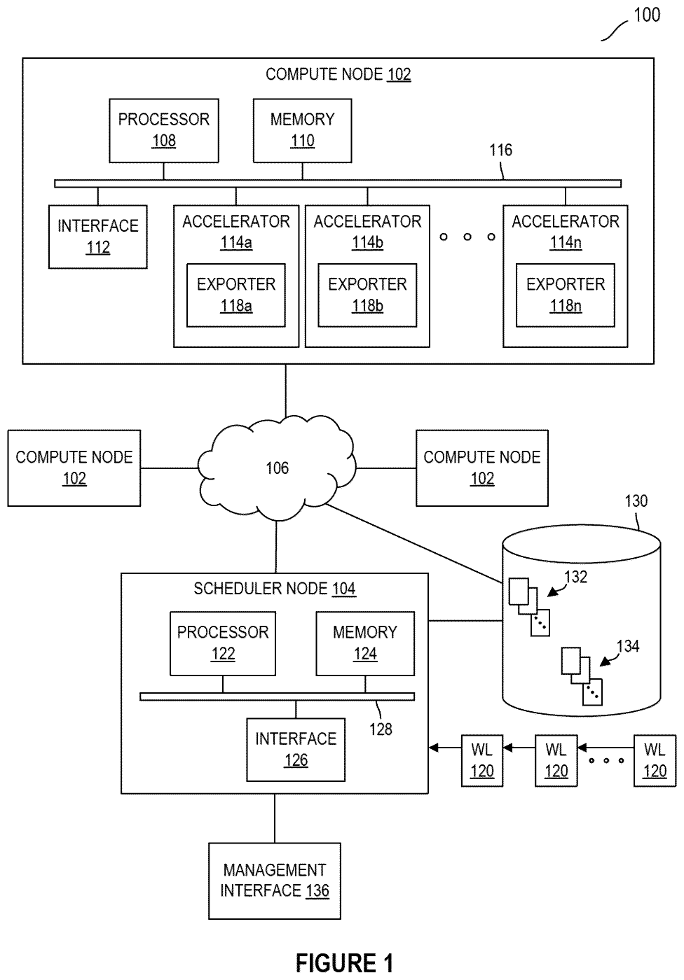

Turning to the figures, FIG. 1 illustrates an example computing system 100 for managing accelerator resources, according to certain implementations. Computing system 100 may be part of a computing environment, such as a containerization environment, a virtualization environment, an HPC environment, a cloud environment, an on-premise environment, or a hybrid cloud environment, some of which may overlap. In some implementation, computing system 100 is capable of parallel execution of computing processes, such as tasks of a workload. Computing system 100 may use a client-server architecture. In the illustrated example, computing system 100 includes multiple compute nodes 102, a scheduler node 104, and a network 106. Although this particular implementation of computing system 100 is illustrated and described, this disclosure contemplates computing system 100 being implemented in any suitable manner.

In certain implementations, compute nodes 102 may work together to perform processing operations, such as cluster operations, HPC operations, and/or other suitable types of computing operations. For example, a workload (e.g., workloads 120, described below) may be divided into smaller segments or tasks that may be parallelized across compute nodes 102. Process(es) may be executed on compute nodes 102 to perform the processing operations associated with the workload. Compute nodes 102 may be implemented using any suitable combination of hardware, firmware, and software. For example, each compute node 102 may be a standalone unit equipped with a processor, memory, and the like (subsequently described).

A workload, which also may be referred to as a computing workload, may include a collection of one or more electronic processing tasks organized in any suitable manner. For example, a workload may include, or be a portion of, one or more software applications, one or more containers, one or more KUBERNETES pods, one or more virtual machines, batch jobs or batch processing tasks, continuous integration/continuous development (CI/CD) pipelines, serverless functions or Function-as-a-service (FaaS) instances, KServe endpoints, notebooks (e.g., JUPYTER), machine learning tasks (e.g., training and/or use tasks), inference tasks for deployed artificial intelligence (AI) models, data analytics jobs (e.g., SPARK jobs), HPC simulations, database instances or database operations, stream processing tasks, web servers, application servers, microservices, distributed ledger or blockchain tasks, and/or any other suitable types of processing tasks, some of which may overlap in type.

A workload may be executed using one or more compute nodes 102, which execute processing tasks, such as tasks of a workload for execution in a potentially parallel manner. For example, these processing tasks may be assigned to compute nodes 102 (e.g., by scheduler node 104) as execution flows that involve compute nodes 102 executing computer code, potentially in portions. To that end, compute nodes 102 may execute one or more processes of the workload, working together to execute the workload.

Compute nodes 102 might or might not be similar to each other. Additional details of one compute node 102 are shown. Compute node 102 includes various hardware components. For example, compute node 102 may include a processor 108, a memory 110, an interface 112, and one or more accelerators 114a-114n (which may be referred to in the singular as accelerator 114 or in the plural as accelerator 114). The hardware components may be interconnected through a number of busses and/or network connections. In one example, processor 108, memory 110, interface 112, and accelerators 114 may be communicatively coupled via a bus 116, such as a PCI-Express bus.

Processor 108 retrieves executable code from the memory 110 and executes the executable code. The executable code may, when executed by processor 108, cause processor 108 to implement any functionality described herein. Processor 108 may be a microprocessor, an ASIC, a microcontroller, or the like. Although referred to in the singular, processor 108 may be multiple processors at one or more locations.

Memory 110 may include various types of memory, including volatile and nonvolatile memory. For example, memory 110 may include Random-Access Memory (RAM), Read-Only Memory (ROM), a Hard Disk Drive (HDD), and/or the like. Different types of memory may be used for different data storage needs. For example, processor 108 may boot from ROM, maintain nonvolatile storage in an HDD, execute program code stored in RAM, and store data under processing in RAM. In certain implementations, a portion or all of memory 110 may be or include a database, such as one or more structured query language (SQL) servers or relational databases. Memory 110 may include a non-transitory computer readable medium that stores instructions for execution by processor 108. One or more modules within compute node 102 may be partially or wholly embodied as software and/or hardware for performing any functionality described herein. Although referred to in the singular, memory 110 may be multiple memory devices at one or more locations.

Memory 110 may include a kernel space and a user space. The kernel space may be a reserved area of memory 110 for running an operating system kernel, kernel extensions, device drivers, and the like. The user space may be an area of memory 110 for running code outside the operating system kernel and generally includes data for running software applications. For example, a task of a workload may be an application executed by processor 108, and data for the workload task may be stored in the user space.

Interface 112 may be used to connect to the network 106 and communicate with other nodes (e.g., other compute nodes 102, scheduler node 104, and/or other suitable entities) over network 106. Interface 112 facilitates the transmission and reception of data packets between compute node 102 and other compute nodes 102 or scheduler node 104 (e.g., via network 106), and may adhere to one or more networking standards such as Ethernet, Wi-Fi, and the like. Although referred to in the singular, interface 112 may be multiple interfaces.

Accelerators 114 may include specialized processing devices that can perform one or more processing tasks, such as those processing tasks that may be associated with certain types of workloads. Examples of accelerators 114 may include GPU devices, ASIC devices, FPGA devices, VPU devices, and/or other types of specialized processing devices that may be incorporated into or otherwise accessible to a compute node 102 to expedite computations for workloads. The accelerator 114 may include a streaming multiprocessor. The accelerator 114 provides significant computational power, allowing for faster execution of some tasks than a general-purpose processor (e.g., the processor 108).

One or more of accelerators 114 may include an exporter 118. In the illustrated example, accelerator 114a includes exporter 118a, accelerator 114b includes exporter 118b, and accelerator 114n includes exporter 118n. Exporters 118a-118n may be referred to generally as exporter 118 or exporters 118. Exporter 118 is configured to collect and report accelerator usage information. Accelerator usage information may include utilization metrics related to the corresponding accelerator 114. The accelerator utilization metrics may include accelerator compute engine utilization metrics (e.g., the percentage of time the accelerator is processing tasks) and/or memory utilization metrics (e.g., the percentage time during which accelerator memory read/write operations were performed). In certain implementations, the accelerator usage information may include temperature (e.g., the current temperature of the accelerator 114), power consumption (e.g., the amount of power the accelerator 114 currently is drawing), clock speeds (e.g., current speeds of accelerator core and memory clocks), memory usage (e.g., the amount of accelerator memory used and available), and/or any other suitable information related to accelerator 114.

Exporter 118 may be implemented using any suitable combination of hardware, firmware, and software. In certain implementations, exporter 118 may be implemented as a container, a daemonset, or in any other suitable manner. Although each accelerator 114 is shown to include a corresponding exporter 118, this disclosure contemplates exporter 118 being deployed in any suitable manner.

Scheduler node 104 receives workloads (now referred to as workloads 120) and assigns workloads 120 to one or more compute nodes 102. Workloads 120 may be scheduled based on a variety of factors, including the states and capabilities of compute nodes 102. Scheduler node 104 may monitor the states and capabilities of compute nodes 102 (e.g., compute utilization, memory utilization, etc.) and make workload scheduling decisions based on the states and capabilities of compute nodes 102. It may be possible to process certain workloads 120, in whole or in part, using one or more accelerators 114. For example, certain workloads 120 may specifically request processing using one or more accelerators 114, certain workloads 120 may allow for processing using one or more accelerators 114, and still other workloads 120 may be configured as not suitable for processing using one or more accelerators 114. Where appropriate, scheduler node 104 may attempt to allocate one or more accelerators 114 to workloads 120 to facilitate processing those workloads 120.

Scheduler node 104 includes various hardware components. Scheduler node 104 might or might not include similar components as those described for compute nodes 102, and might or might not also serve as a compute node (e.g., a compute node 102) for processing workloads 120. In the illustrated example, scheduler node 104 includes a processor 122, a memory 124, and an interface 126. The hardware components may be interconnected through a number of busses and/or network connections. In one example, processor 122, memory 124, and interface 126 may be communicatively coupled via a bus 128, such as a PCI-Express bus.

Processor 122 retrieves executable code from memory 124 and executes the executable code. The executable code may, when executed by processor 122, cause processor 122 to implement any functionality described herein. Processor 122 may be a microprocessor, an application-specific integrated circuit, a microcontroller, or the like. Although referred to in the singular, processor 122 may be multiple processors at one or more locations.

Memory 124 may include various types of memory, including volatile and nonvolatile memory. For example, memory 124 may include RAM, ROM, an HDD, and/or the like. Different types of memory may be used for different data storage needs. For example, processor 122 may boot from ROM, maintain nonvolatile storage in an HDD, execute program code stored in RAM, and store data under processing in RAM. In certain implementations, a portion or all of memory 124 may be or include a database, such as one or more SQL servers or relational databases. Memory 124 may include a non-transitory computer readable medium that stores instructions for execution by processor 122. One or more modules within scheduler node 104 may be partially or wholly embodied as software and/or hardware for performing any functionality described herein. Although referred to in the singular, memory 124 may be multiple memory devices at one or more locations.

Memory 124 may include a kernel space and a user space. The kernel space may be a reserved area of memory 124 for running an operating system kernel, kernel extensions, device drivers, and the like. The user space may be an area of memory 124 for running code outside the operating system kernel and generally includes data for running software applications. For example, a workload scheduler may be an application executed by processor 122, and data for the workload scheduler may be stored in the user space.

Interface 126 may be used to connect to network 106 and communicate with other nodes over network 106. Interface 126 facilitates the transmission and reception of data packets between scheduler node 104 and compute nodes 102 (e.g., via network 106), and may adhere to one or more networking standards such as Ethernet, Wi-Fi, and the like. Although referred to in the singular, interface 126 may be multiple interfaces.

Network 106 may be any suitable type of communication network for electronic devices, and may facilitate wired and/or wireless communication. Network 106 may communicate, for example, IP packets, Frame Relay frames, ATM cells, voice, video, data, and other suitable information between network addresses. Network 106 may include any suitable combination of one or more local area networks (LANs), radio access networks (RANs), metropolitan area networks (MANs), wide area networks (WANs), mobile networks (e.g., using WiMax (802.16), WiFi (802.11), 3G, 4G, 5G, or any other suitable wireless technologies in any suitable combination), all or a portion of the global communication network known as the Internet, and/or any other communication system or systems at one or more locations, any of which may be any suitable combination of wireless and wired. Network 106 may include controllers, APs, switches, routers, firewalls, or the like for forwarding traffic.

Network 106 may facilitate the coordination and synchronization of compute nodes 102 and scheduler node 104 when processing workloads 120 and other associated tasks. In certain implementations, the components of some or all of network 106 work together to provide a high-bandwidth interconnection between compute nodes 102 and scheduler node 104. The design of at least a portion of network 106 may prioritize low latency and high throughput among the connected components. For example, some or all of network 106 may be based on a technology such as Ethernet, InfiniBand, or the like.

Computing system 100 may include a storage device 130. Although illustrated separately from scheduler node 104, scheduler node 104 may include storage device 130 in certain implementations (e.g., as part of memory 124). Storage device 130 may include various types of memory, including volatile and nonvolatile memory. For example, storage device 130 may include RAM, ROM, an HDD, and/or the like. In certain implementations, a portion or all of storage device 130 may be or include a database, such as one or more SQL servers or relational databases. Although referred to in the singular, storage device 130 may be multiple storage devices at one or more locations.

Storage device 130 may store workload information 132 and accelerator usage information 134. Workload information 132 may include any suitable information about workloads 120. For example, workload information 132 may include one or more categories for a workload 120, one or more priorities for a workload 120, a start time for a workload 120, and/or any other suitable information about a workload 120. The one or more categories for a workload 120 could include a framework (e.g., KUBERNETES, SPARK, LIVY, RAY, etc.) associated with the workload 120, a project (e.g., Project A, Project B, etc.) associated with a workload 120, a department (e.g., Billing, IT, Human Resources, etc.) associated with a workload 120, a user associated with a workload 120 (e.g., user 1, user 2, etc.), and/or any other suitable categories for a workload. The one or more priorities may define one or more priority levels for a workload 120, which generally may be relatable to the priorities associated with at least some other workloads 120 (e.g., other workloads 120 associated with the same tenant) for purposes of comparing the relative priorities of workloads 120. In some implementations, priorities may be associated with one or more categories assigned to workloads 120. As just one example, workloads 120 associated with Project A may have a higher priority than workloads associated with Project B. The start time for a workload 120 may identify a time at which a workload 120 has been allocated resources (including, potentially, one or more accelerators 114) and otherwise deployed to one or more compute nodes 102 for processing, and may be updated once the workload 120 has the ability to begin processing. These examples of workload information 132 may be useful for various reasons described in greater detail below.

In certain implementations, scheduler node 104 (or another suitable component) may determine some or all of workload information 132 and store that workload information in storage device 130. In certain implementations, some or all of workload information 132 may be determined from information included in workloads 120, such as information included in annotations/labels and/or other metadata of workloads 120. Some or all of workload information 132 may be determined according to the manners in which scheduler node 104 handles the corresponding workload, such as which, if any, accelerator 114 is allocated to the workload and other associated information. Workload information 132 may be stored with or separately from workloads 120.

Accelerator usage information 134 may include any suitable information about accelerators 114, workloads 120, and/or any other suitable information. For example, accelerator usage information 134 may include some or all accelerator usage information (e.g., utilization metrics) reported by exporters 118. Accelerator usage information 134 may include information scheduler 104 can use to determine whether accelerator resources are being used, and if not, how long the accelerator resources have remained unused.

In certain implementations, some or all of accelerator usage information 134 is retrieved and stored as time series data in storage device 130. For example, some or all of storage device 130 may be implemented as a PROMETHEUS or other suitable type of database that is configured to collect accelerator usage information, such as utilization metrics or other suitable usage information, from exporters 118 at a regular or irregular interval.

Although described separately, workload information 132 and accelerator usage information 134 may be stored separately or together. For example, workload information 132 and accelerator usage information 134 may be comingled such that workload information 132 and accelerator usage information 134 pertinent to a particular workload 120 and its assigned one or more accelerators 114 are combined in a suitable manner, and that information may itself be stored as separate information from workload information and/or accelerator usage information 134. Furthermore, workload information 132 and accelerator usage information 134 may be analyzed to derive additional information that might be pertinent to a particular workload 120 and its assigned one or more accelerators 114, and that derived information also may be stored as part of or separate from workload information 132 and/or accelerator usage information 134.

As described above, scheduler node 104 may determine that certain workloads 120 can be processed, in whole or in part, using one or more accelerators 114, such as using one or more accelerator resources. For a workload 120 that can be processed using one or more accelerators 114, scheduler node 104 may attempt to allocate one or more accelerators 114 to that workload 120 and ultimately facilitate deploying the workload 120 to the one or more appropriate compute nodes 102 for processing using the allocated one or more accelerators 114. To simplify the description, it will be assumed that, to the extent scheduler node 104 allocates an accelerator 114 to a workload 120, scheduler node 104 allocates a single accelerator 114 to that workload 120, and allocates the entire processing capability of that single accelerator 114 to that workload. This disclosure, however, contemplates scheduler node 104 assigning any suitable number of accelerators 114 to a workload 120, and assigning portions of the processing capability of an accelerator 114 to a workload 120.

This disclosure uses the term accelerator resources in various portions of the description. In certain implementations, accelerator resources may include one or more accelerators 114 and, for each of the one or more accelerators 114, a portion or all of the processing capability of the accelerator 114. The accelerator resources may include one or more physical accelerators and/or one or more virtual accelerators. In certain implementations, allocating accelerator resources to a workload 120 reserves those accelerator resources for that workload 120.

Once a workload 120 has been allocated resources (e.g., including, potentially, accelerator resources) and has been deployed to one or more compute nodes 102 for processing, the workload 120 may be considered a running workload 120. In some scenarios, although a workload 120 is running, workload 120 may become idle and stop using some or all resources allocated to the workload 120, leaving the accelerator resources and/or other resources that have been allocated to that workload 120 idle. In certain implementations, scheduler node 104 may execute a reclamation process through which scheduler node 104 may identify the accelerator resources that have been allocated to workloads 120 but that are idle, according to certain criteria. The reclamation process may include reallocating accelerator resources that have been allocated to workloads 120 but are identified as idle to other workloads 120 that are pending. The pending workloads 120 may be waiting in a workload queue (or other suitable data structure) for computing resources (e.g., including, potentially, accelerator resources) to become available for allocating to the pending workload 120.

In operation of an example implementation of the reclamation process, scheduler node 104 may monitor the use of accelerator resources by workloads 120 that are running. For example, scheduler node 104 may obtain, at a suitable interval, accelerator usage information 134. The accelerator usage information 134 may include utilization metrics and/or other usage information that can be used to determine whether particular accelerator resources have been used over a time period. In some implementations, the accelerator usage information 134 may be used to determine an average use (e.g., an average accelerator utilization) of particular accelerator resources over a time period.

Continuing with the example of the reclamation process, based on monitoring the use of the accelerator resources allocated to workloads 120 that are running, scheduler node 104 may determine whether the use of an accelerator resource satisfies an idleness condition. The idleness condition may be designed to determine whether or not a workload 120 to which accelerator resources have been allocated is making adequate use of those allocated accelerator resources. A particular workload 120 not satisfying (failing to satisfy) the idleness condition may mean that the particular workload 120 has made sufficient use of the accelerator resources that are allocated to the particular workload 120, and that the accelerator resources allocated to the particular workload 120 are not to be reallocated to a pending workload 120 at this time (are not to be reclaimed). Conversely, a particular workload 120 satisfying the idleness condition may mean that the particular workload 120 has made insufficient use of the accelerator resources that are allocated to the particular workload 120, and that the accelerator resources allocated to the particular workload 120 are to be reallocated to a pending workload 120 (are to be reclaimed).

This disclosure contemplates implementing the idleness condition in any suitable manner. In certain implementations, the idleness condition is implemented at least in part using an idleness threshold. The idleness threshold may define an amount of use of the accelerator resources that a workload 120 is expected to achieve or risk satisfying the idleness condition and losing the allocation of the accelerator resources. The idleness condition may include a time component that supplements the idleness threshold. For example, time component may be referred to as an idle time threshold, and may be a time period over which accelerator usage is considered to determine whether usage of the accelerator resources by a workload 120 satisfies the idleness threshold. The idleness threshold may be expressed as a minimum usage percentage that is expected to be achieved over the time period defined by the idle time threshold.

For a particular workload 120, the average usage rate for the accelerator resources allocated to the particular workload 120 for the applicable time period may be obtained (e.g., by accessing accelerator usage information 134, potentially as capture by or determined from utilization metrics) and compared to the idleness threshold to determine whether the use of the accelerator resources allocated to the particular workload 120 satisfies the idleness threshold. The term “satisfying” could mean less than, less than or equal to, greater than, greater than or equal to, or equal to, depending on the implementation. For ease of description, for purposes of the examples described throughout this disclosure, it will be assumed that satisfying the idleness threshold means a value (e.g., average accelerator usage (e.g., utilization) over an applicable time period) is greater than the idleness threshold.

Additionally, the particular time period defined by the idle time threshold could be any suitable time period. As an example, the time period could correspond to the time interval between execution of the reclamation process. As another example, the time period could correspond to the time for a particular number of collections of accelerator usage metrics (e.g., as time series data) from accelerators 114 to occur. As another example, the time period could be an arbitrary number that is determined to be important by a system administrator of at least a portion of computing system 100 or another suitable user.

In a first example, the idleness threshold may be defined as zero and the associated idle time threshold may be five minutes. With these parameters, a particular workload 120 may satisfy the idleness condition, and thereby not have the accelerator resources that have been allocated to the particular workload 120 reallocated to a pending workload 120 (reclaimed), if the average accelerator usage by the particular workload 120 over the time period defined by the idle time threshold (e.g., as determined from accelerator usage information 134) exceeds zero. That is, in this example, a value of zero for the idleness threshold essentially enforces a condition in which a workload that does not make at least some use of the accelerator resources that have been assigned to it risks losing those accelerator resources.

A particular workload 120 not satisfying (failing to satisfy) the idleness threshold may mean that the particular workload 120 has made insufficient use of the accelerator resources that are allocated to the particular workload 120 over the time period defined by the idle time threshold, and that the accelerator resources allocated to the particular workload 120 are to be reallocated to a pending workload 120. Conversely, a particular workload 120 satisfying the idleness threshold may mean that the particular workload 120 has made sufficient use of the accelerator resources that are allocated to the particular workload 120 over the time period defined by the idle time threshold, and that the accelerator resources are not to be reallocated to a pending workload 120 (not to be reclaimed) at this time.

As another example, the idleness threshold may be defined as twenty percent and the associated idle time threshold may be five minutes. With these parameters, a particular workload 120 may satisfy the idleness condition, and thereby not have the accelerator resources that have been allocated to the particular workload 120 reallocated to a pending workload 120, if the average accelerator usage by the particular workload 120 over the defined time period defined by the idle time threshold (e.g., as determined from accelerator usage information 134) exceeds twenty percent. That is, in this example, a value of twenty percent for the idleness threshold essentially enforces a condition in which a workload that does not have an average usage rate of the accelerator resources of more than twenty percent for the time period defined by the idle time threshold risks losing those accelerator resources.

Based at least on determining that the use of an accelerator resource by a particular workload 120 satisfies the idleness condition (e.g., has been used insufficiently), scheduler node 104 may reallocate the accelerator resource to one or more other workloads 120, thereby reclaiming the accelerator resource. The accelerator resource that is being reallocated may be referred to as a reclaimed accelerator resource. In certain implementations, reallocating an accelerator resource to one or more other workloads may include deallocating the accelerator resource from the particular workload 120. For example, scheduler node 104 may communicate a notification to the particular workload 120 informing the particular workload 120 that an accelerator resources is being reclaimed.

The particular computing workload 120 from which the accelerator resource is being reclaimed (e.g., is being deallocated) can be handled in any suitable manner. In certain implementations, the particular computing workload 120 may be placed in a pending workload queue, eligible to be assigned accelerator resources along with other pending computing workloads 120 according to applicable scheduling policies. This approach may be referred to as non-destructive preemption, as this approach moves computing workloads 120 from which accelerator resources have been reclaimed to a pending state rather than terminating those computing workloads 120. Of course, this disclosure contemplates simply terminating those computing workloads 120 or handling them in some other manner, if appropriate.

The one or more other workloads 120 to which the accelerate resource is reallocated may be pending workloads 120, such as workloads 120 that are in a workload queue awaiting available accelerator resources. To the extent multiple pending workloads 120 are present, this disclosure contemplates any suitable techniques for scheduler node 104 to determine which pending workloads 120 will be allocated the reclaimed accelerator resources. The selection of which one or more pending workloads 120 are to be reassigned the newly-available accelerator resources (e.g., those being reclaimed due to idle behavior of the workload 120 to which those accelerator resources were previously allocated) may consider a variety of factors. Those factors may include one or more of the total available accelerator resources that have are being reclaimed, the accelerator resource needs of the pending workloads 120 (individually and possibly in combinations), the relative priorities of the pending workloads 120, and/or any other suitable factors. The relative importance of these (and possibly others suitable) factors may vary from implementation to implementation.

As described above, in certain implementations, workloads 120 may have one or more assigned priorities. Scheduler node 104 may be configured to evaluate the priorities of pending workloads 120 when determining which pending one or more workloads 120 will be allocated reclaimed accelerator resources.

For example, an implementation may be configured such that the relative priorities of the pending workloads 120 is the most important factor in determining which pending workload 120 will be allocated the reclaimed accelerator resources, with a possible tiebreaker being the positions of pending workloads 120 having the same highest priority in the pending workload queue such that the oldest of the pending workloads 120 having the same highest priority will be allocated the reclaimed accelerator resources.

As another example, an implementation may be configured such that the relative priorities of the pending workloads 120 is the most important factor in determining which pending workload 120 will be allocated the reclaimed accelerator resources, with a possible tiebreaker being the positions of pending workloads 120 having the same highest priority in the pending workload queue such that the oldest of the pending workloads 120 having the same highest priority will be allocated the reclaimed accelerator resources.

It is possible that different workloads 120 (pending and running) may call for different amounts of accelerator resources. As a result, in some scenarios, the amount of accelerator resources that are reclaimed at a particular time as a result of an idle workload 120 may be sufficient for some pending workloads 120 (or combinations of pending workloads 120) but insufficient for other pending workloads 120 (or combinations of pending workloads 120). Scheduler node 104 may be configured to consider this information in determining which pending workloads 120 will be allocated reclaimed accelerator resources. In an example in which the reclaimed accelerator resources are insufficient for the higher priority pending workloads 120 but sufficient for the lower priority pending workloads 120, different possible configurations exist, two examples of which are described below.

In a first possible example configuration, the higher priority pending workloads 120 may be favored over the lower priority pending workloads 120 even after scheduler node 104 determines that the reclaimed accelerator resources are insufficient for the higher priority pending workloads 120. As a result, rather than allocate those reclaimed accelerator resources to one or more lower priority workloads 120, scheduler node 104 may reserve those reclaimed accelerator resources for future combination with other reclaimed (or even released) accelerator resources so that the higher priority pending workloads 120 can be allocated accelerator resources before the lower priority pending workloads 120. In a second possible example configuration for this scenario, based at least on scheduler node 104 determining that the reclaimed accelerator resources are insufficient for the higher priority pending workloads 120 but are sufficient for one or more lower priority pending workloads 120, scheduler node 104 may allocate those reclaimed accelerator resources to one or more lower priority workloads 120 so that those reclaimed accelerator resources do not continue to sit idle.

The reclamation process may be implemented as a scheduled process (e.g., a cron job) that is scheduled to run at a suitable regular or irregular time interval. Additionally or alternatively, the reclamation process may be performed in response to a particular event. As just one example, the scheduler node 104 may run the reclamation process in response to a new workload 120 being added to a pending workload queue (e.g., in response to determining that accelerator resources for processing a new workload 120 are unavailable and that the new workload 120 will remain in the pending workload queue). Additional details of example implementations of the reclamation process are described throughout the remainder of this disclosure.

In certain implementations, the criteria for determining whether an accelerator resource satisfies an idleness criteria and/or for determining which pending workload(s) 120 will be allocated reclaimed accelerator resources are configurable through adjustment of one or more parameters. For example, configurable parameters may include one or more of an idleness thresholds, an idle time threshold, a toleration time period, and prioritization information.

In certain implantations, to facilitate the configurability of these parameters and to monitor statuses of accelerator resources and workloads 120, computing system 100 may include a management interface 136, which may be used to control scheduler node 104, among other elements of computing system 100, if appropriate. A system administrator or other suitable human or machine user may access scheduler node 104 using management interface 136. Management interface 136 may be a central point of access for scheduler node 104, which is accessible from a public computer network such as the internet. Scheduler node 104 may receive commands via management interface 136. Scheduler node 104 may process the commands from management interface 136, validate the commands, and execute logic specified by the commands. Further, scheduler node 104 may output the results of commands via management interface 136. Examples of management interface 136 include a command line interface, a graphical user interface, a web interface, or the like.

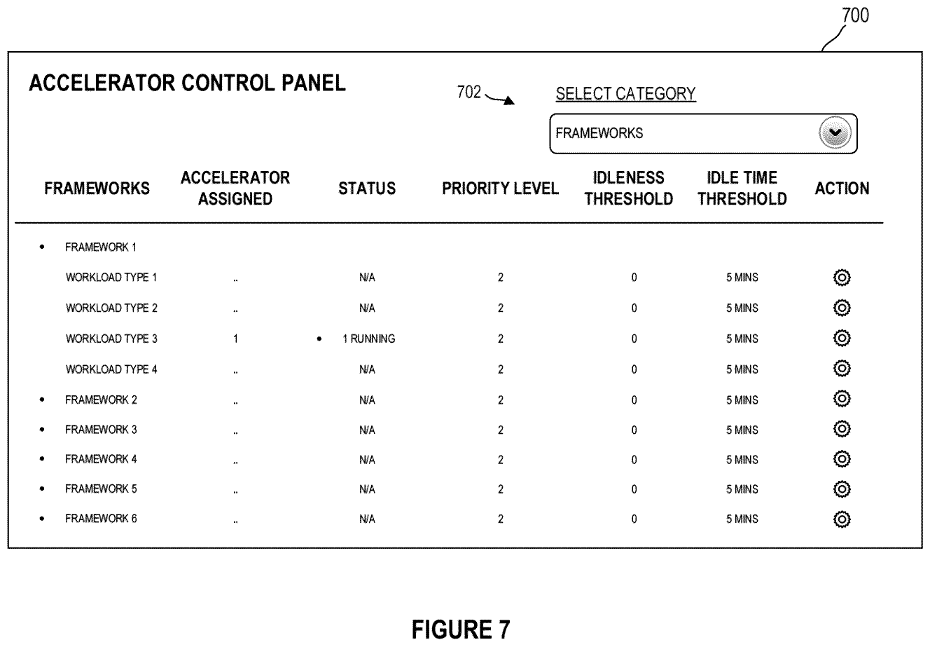

In certain implementations, management interface 136 may display information about workloads 120 and the use of accelerators 114 to process those workloads 120. A particular example of a display of management interface 136 is illustrated and described below with reference to FIG. 7.

In certain implementations, management interface 136 may be used to configure/customize various parameters associated with the reclamation process performed by scheduler node 104. For example, management interface 136 may be used to specify/modify one or more aspects of the idleness condition for determining whether an accelerator 114 is idle, to change a priority of a workload 120, to change a category of a workload 120, and/or to perform other suitable operations. As a particular example, in relation to the idleness condition, management interface 136 may be used to specify/modify an idleness threshold, an idle time threshold, and/or other suitable information.

Continuing with FIG. 1, compute nodes 102 and scheduler node 104 may include any suitable combination of hardware, firmware, and software, which may cooperate to provide the features of computing system 100. Additionally, where appropriate, each of compute nodes 102 and scheduler node 104 may include one or more computer systems at one or more locations. Each computer system may include any appropriate input devices, output devices, mass storage media, processors, memory, or other suitable components for receiving, processing, storing, and communicating data. Although illustrated and described separately, compute nodes 102 and scheduler node 104 may be combined or further separated in any suitable manner. For example, these components may be implemented using one or more computing devices at one or more geographic locations. Accordingly, implementations disclosed herein should not be limited to the configuration of components shown in FIG. 1.

This disclosure contemplates the reclamation process being used with any suitable type of computing system. For example, the reclamation process may be used with any suitable type of computing system in which resources may be allocated to particular resource-using entities, those resource-using entities may allow allocated resources to sit idle, and other resource-using entities may be waiting for resources.

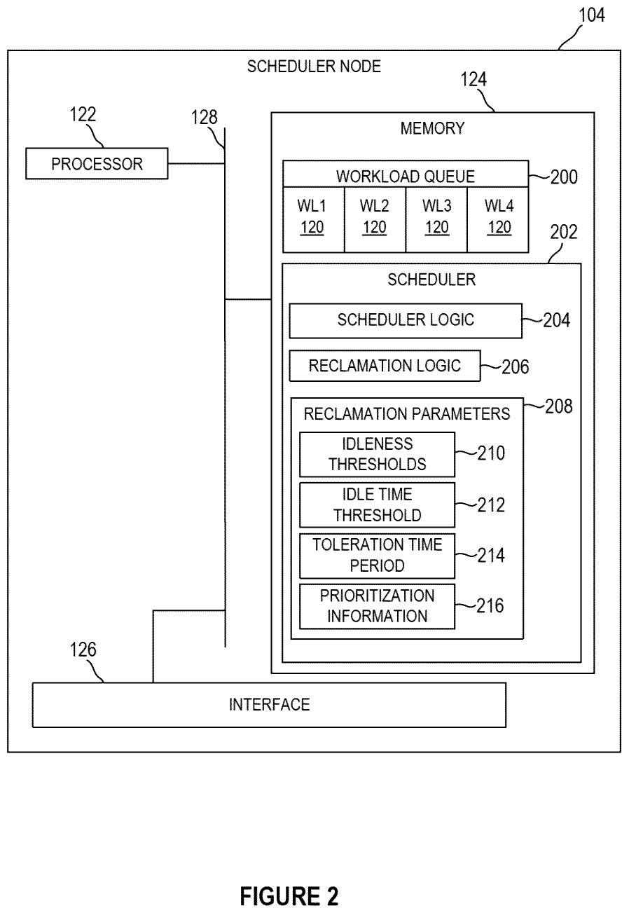

FIG. 2 illustrates additional details of scheduler node 104, according to certain implementations. For example, FIG. 2 illustrates additional details of a computer system that is configured to implement scheduler node 104, according to certain implementations. In the illustrated example, and as described in detail above with reference to FIG. 1, scheduler node 104 includes processor 122, memory 124, interface 126, and bus 128.

Returning to memory 124, in the illustrated example, memory 124 stores workload queue 200 and scheduler 202. Each of these are described in greater detail below.

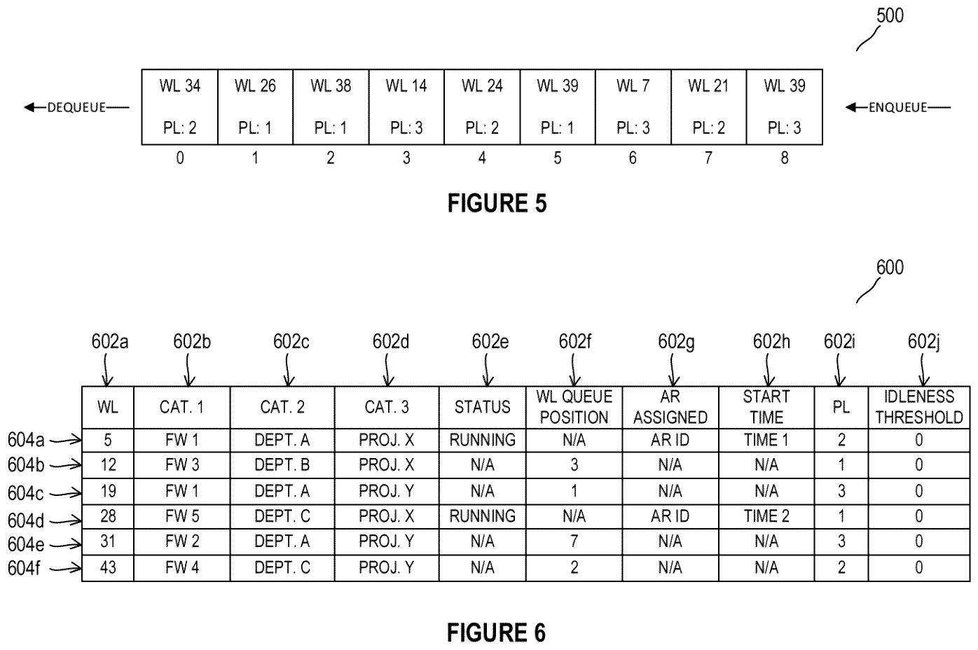

Workload queue 200 may be a data structure that stores pending workloads 120. Although described as a queue, workload queue 200 may be any suitable type of data structure. Although described as storing workloads 120, workload queue 200 may store one or more of the actual workloads 120, pointers to workloads 120, selected information from workloads 120, and/or any other suitable information about workloads 120. An example workload queue 200 is described in greater detail below with reference to FIG. 5.

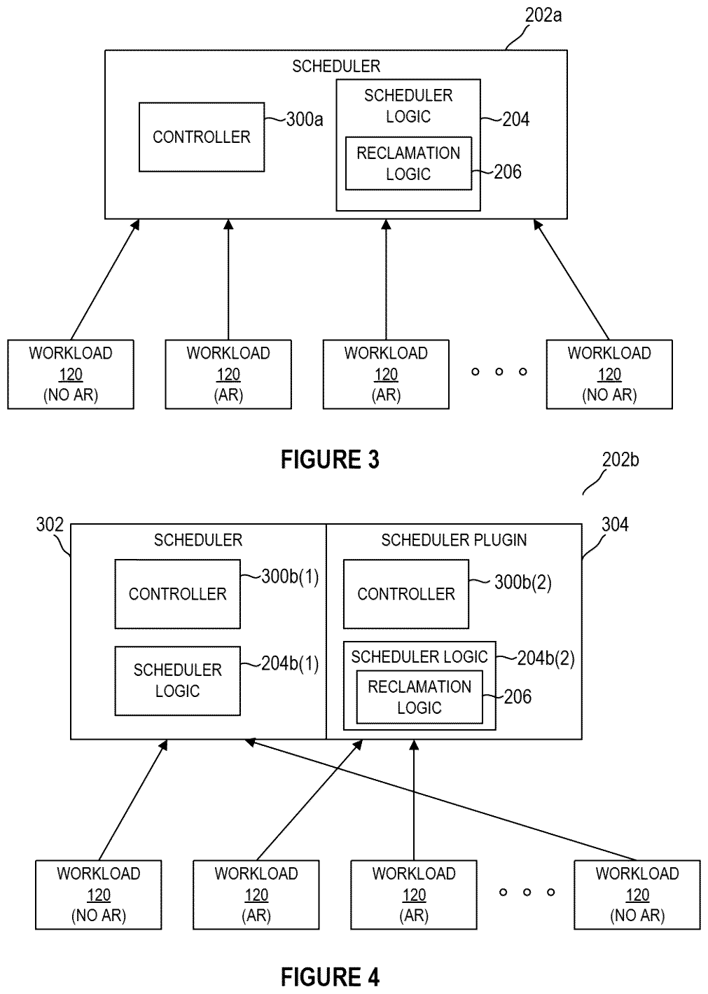

Scheduler 202 may represent the collection of instructions and information that configure scheduler node to perform scheduling operations, including the reclamation process described herein. In the illustrated example, scheduler 202 includes scheduler logic 204, reclamation logic 206, and reclamation parameters 208. Although scheduler 202 in shown and described to include these particular items, scheduler 202 may include these and or different items. Furthermore, although items of scheduler 202 are shown to be separated or combined in particular ways, other configurations are possible. Two example configurations of scheduler 202 are described below with reference to FIGS. 3 and 4.

Continuing with FIG. 2, scheduler logic 204 may represent instructions for scheduling workloads 120, while reclamation logic 206 represents instructions for implementing the reclamation process and associated scheduling described herein. For example, reclamation logic 206 may include, among other features, the logic for monitoring accelerator resources, determining which accelerator resources satisfy an idleness condition, and reallocation accelerator resources that have been determined to satisfy the idleness condition.

Reclamation logic 206 may use reclamation parameters 208 to perform the reclamation process. In the illustrated example, reclamation parameters 208 include one or more idleness thresholds 210, one or more idle time thresholds 212, one or more toleration time periods 214, and prioritization information 216. Although reclamation parameters 208 are shown to include particular parameters, reclamation parameters 208 may include these and/or other parameters, if appropriate.

Although shown in the plural, the different reclamation parameters 208 may be referred to in the singular or the plural. In certain implementations, it may be possible to define different reclamation parameters 208 for different categories of workloads 120, for different tenants of a computing environment (e.g., computing system 100), and/or for other reasons. Each of these example reclamation parameters 208 is described below.

Idleness threshold 210 may define an amount of use of the accelerator resources that a workload 120 is expected to achieve or risk having the accelerator resources reclaimed (e.g., losing the allocation of the accelerator resources) by scheduler node 104. Although this disclosure contemplates any suitable parameter (or combination of parameters) being evaluated to measure “use” of accelerator resources, in certain implementations, idleness threshold 210 may be expressed as a percentage use. Idleness threshold 210 may be expressed as a minimum usage percentage that is expected to be achieved. For example, as a utilization metric, 0% may indicate that the accelerator resources are idle for a time period measured, while 100% may indicate that the accelerator resources are fully utilized for the time period measure. In such an example, idleness threshold 210 may be set to 0%, 20%, 40%, or any other suitable percentage. In certain implementations, a higher idleness threshold 210 establishes a higher amount of accelerator utilization to avoid being characterized as idle.

Idle time threshold 212 represent may represent a time component of the idleness condition. This time component may supplement idleness threshold 210. For example, idle time threshold 212 may be a time period over which accelerator resource usage is considered to determine whether usage of the accelerator resource by a workload 120 satisfies idleness threshold 210. Idleness threshold 210 may be expressed as a minimum usage percentage that is expected to be achieved over the time period defined by idle time threshold 212. As a particular example, if idleness threshold is 0% and an idle time threshold 212 of 300s, usage of an accelerator resource by a workload 120 should be greater than 0% over a relevant 300s time period to avoid the accelerate resource being characterized as idle.

Toleration time period 214 may define a delay before a workload 120 that has been allocated an accelerator resource will be evaluated for idleness, to allow the workload 120 to start up and initialize before beginning to use the accelerator resource. A start time for the workload 120 may be determined from workload information 132 or another suitable source, and the toleration time period 214 may be calculated from the start time. Once the toleration time period 214 expires, the workload 120 and its allocated accelerator resources may be evaluated for idleness and possible reclamation of accelerator resources.

Prioritization information 216 may include information identifying the relative priority levels that are assigned to different categories for workloads 120. As described above, workload information 132 may include a one or more categories for a workload 120. Prioritization information 216 may include a mapping between those categories and the priority assigned to a particular category.

FIG. 3 illustrates an example scheduler 200a, according to certain implementations. Scheduler 200a represents a possible implementation of scheduler 202 of FIG. 2. In the illustrated example of FIG. 3, scheduler 202a includes a controller 300a and scheduler logic 204, each of which may be implemented using any suitable combination of hardware, firmware, and software.

Controller 300a may be a core component of the underlying computing environment software through which computing system 100 is operating. As just a few examples, the controller 300a could be a core component of the software and associated services for implementing a virtualization environment, a cluster environment, a container environment, and/or any other suitable type of computing environment. In certain implementations, controller 300a may operate at a control plane level of the computing environment (e.g., computing system 100).

As described above with reference to FIG. 2, scheduler logic 204 may represent instructions for scheduling workloads 120, while reclamation logic 206 represents instructions for implementing the reclamation process described herein. In the example shown in FIG. 3, reclamation logic 206 is part of scheduler logic 204 for scheduler 202a.

Some workloads 120 may be suitable for processing with accelerator resources, while others might not be suitable processing with accelerator resources. In the illustrated example, the indicator “(NO AR)” is used to identify workloads 120 that are unsuitable for processing with accelerator resources, and the indicator (“AR)” is used to identify workloads 120 that are suitable for processing using accelerator resources. In the implementation illustrated in FIG. 3, workloads 120 may be directed to scheduler 202a regardless of whether those workloads 120 are suitable for processing with accelerator resources, as scheduler logic 204 of scheduler 202a includes reclamation logic 206 for executing the reclamation process of this disclosure, where appropriate.

FIG. 4 illustrates an example scheduler 202b, according to certain implementations. Scheduler 202b represents a possible implementation of scheduler 202 of FIG. 2. In the illustrated example, scheduler 202b includes scheduler 302 and scheduler plugin 304.

Scheduler 202b may be considered a default scheduler that provides default scheduling functions associated with the computing environment (e.g., computing system 100 of FIG. 1). Scheduler 202b could be a scheduler provided by a framework upon which computing system 100 (see FIG. 1) operates. As just one example, scheduler 202b could be a KUBERNETES scheduler that provides scheduling operations within the context of a KUBERNETES system.

As illustrated in FIG. 4, scheduler 302 may include a controller 300b (1) and scheduler logic 204b (1), each of which may be implemented using any suitable combination of hardware, firmware, and software. Controller 300b (1) may be similar to controller 300a described above with reference to FIG. 3. Scheduler logic 204b (1) in FIG. 4 may provide the default scheduling functionality of scheduler 202b. For example, scheduler logic 204b (1) of FIG. 4 may provide the default scheduling operations associated with a framework (e.g., KUBERNETES) upon which computing system 100 (see FIG. 1) operates.

In the example of FIG. 4, the reclamation and associated scheduling features of scheduler 202b are provided via a scheduler plugin 304 that plugs into and operates alongside scheduler 302 (the default scheduler). The reclamation and associated scheduling features of scheduler plugin 304 can supplement the default scheduling features of scheduler 302. In the example of FIG. 4, scheduler plugin 304 includes a controller 300b (2) and scheduler logic 204b (2), which includes reclamation logic 206.

Controller 300b (2) may be similar to controller 300a described above with reference to FIG. 3 and controller 300b (1) described above with reference to scheduler 302 of FIG. 4. Scheduler logic 204b (2) may provide capabilities to schedule workloads that are suitable for processing with accelerating resources. Reclamation logic 206 represents instructions for implementing the reclamation process described herein.

As described above, some workloads 120 may be suitable for processing with accelerator resources (indicated with “(AR)”), while other workloads 120 might not be suitable processing with accelerator resources (indicated with “(NO AR)”). In certain implementations of scheduler 202b, workloads 120 that are candidates for allocation of accelerator resources for processing at least a portion of the workload 120 may be modified to call scheduler plugin 304, as scheduler plugin 304 allows provides the additional ability for reclamation. The technique for modifying workloads 120 to call scheduler plugin 304 may vary depending on the type of computing environment. In an example of KUBERNETES where workloads 120 may include pods, a pod's configuration/runtime specification may be modified to set scheduler plugin 304 as the scheduler for the pod to the extent those pods are capable of being processed using accelerator resources. For example, those pods may be modified so that the spec.schedulerName is set to scheduler plugin 304. Workloads 120 that are not candidates for allocation of accelerators 114 may continue to point to scheduler 302 for scheduling. Of course, other implementations are possible.

FIG. 5 illustrates additional details of an example of workload queue 200 of FIG. 2, according to certain implementations. Workload queue 200 may store pending workloads, that is workloads awaiting adequate resources, which might or might not include accelerator resources, to be available for allocation to those workloads. The workloads shown in workload queue 200 may be examples of workloads 120, described elsewhere. Workload queue 200 may store the workloads themselves or pointers to the workloads, possibly with other suitable information about the workloads.

For purposes of this example, it will be assumed that workload queue 200 is a first-in, first-out queue (FIFO) queue, enqueueing from the right and dequeuing from the left. In this regard, the left-most position in workload queue is shown as position 0, with position numbers increasing to the right.

Although generally configured as a FIFO queue, with the exception that scheduler node 104 (e.g., scheduler 202 of FIG. 2) has the ability to analyze prioritization levels or other factors of workloads when determining a next workload to assign to a reclaimed accelerator resource. To that end, FIG. 5 shows workloads (abbreviated as “WL #” in FIG. 5), along with an indication of a priority level (abbreviated as “PL #” in FIG. 5) for that workload. In this example, it is assumed three priority levels (1, 2, and 3) are possible, with PL 1 being the highest priority and PL 3 being the lowest priority. In certain implementations, scheduler node 104 may select a workload with the highest priority, with ties resulting in selection of the oldest workload (e.g., according to position in workload queue 200) having that priority level. Furthermore, the workload numbers (e.g., 34, 26, 38, etc.) are not necessarily meant to imply an order of arrival to scheduler node 104/workload queue 200. Instead, these numbers simply represent workload identifiers. Of course, other implementations are possible.

In the illustrated example, assuming scheduler node 104 has reclaimed an accelerator resource from a running workload, and that reclaimed accelerator resource is sufficient for any workload in workload queue 200, scheduler node 104 may analyze the relative priority levels of the workloads in workload queue 200 and determine that workloads 26 (position 1), 38 (position 2) and 39 (position 5) have the highest priority among the pending workloads in workload queue 200. In certain implementations, because workload 26 is in position 1, meaning that it has been in workload queue 200 longer than 38 or 39—and therefore has been waiting longer for a resource allocation—scheduler node 104 may determine to that the reclaimed accelerator resource is to be reallocated to workload 26.

The description of FIG. 5 has assumed a scenario in which applicable idleness threshold is consistent across all computing workloads in workload queue 200 are the same. More complex implementations are possible. For example, a particular idleness threshold may be defined for certain categories of computing workloads, while a different one or more idleness thresholds may be defined for other categories of computing workloads. In such implementations, determining which computing workload will be allocated a reclaimed accelerator resource may include more complex determinations.

FIG. 6 illustrates an example of workload information table 600, which may include and/or be part of workload information 132 of FIG. 1, according to certain implementations. In the illustrated example, workload information table 600 includes multiple columns 602a-602j (referred to generally as columns 602) and multiple rows 604a-604f (referred to generally as rows 604). Columns 602 correspond to particular types of information, and rows 604 correspond to particular workloads (e.g., workloads 120 of FIG. 1). Although FIG. 6 shows information being stored in table format (e.g., in workload information table 600), this disclosure contemplates workload information 132 being stored in any suitable format. The content of the different columns 602 is now described.

Column 602a indicates a workload identifier (ID), with workload being abbreviated as WL in the header. In this example, the workload ID is an integer, but any suitable ID may be used.

Columns 602b through 602d identify different category types to which workloads may be assigned. For example, column 602b, column 602c, and column 602d correspond to category 1 (CAT. 1), category 2 (CAT. 2), and category 3 (CAT. 3), respectively. This disclosure contemplates workloads 120 being assigned to any suitable numbers and types of categories, including none if appropriate for particular implementations. For this example, category 1 specifies a framework associated with the workload, category 2 specifies a department associated with the workload, and category 3 specifies a project associated with the workload.

Column 602e identifies a status of the workload. The status may indicate whether the workload 120 is running. As described previously, a running workload 120 may be a workload that has been assigned resources (and possibly accelerator resources) and is deployed (e.g., to one or more compute nodes 102 of FIG. 1) for execution. In this example, workloads 5 (row 604a) and 28 (row 604d) are running. The remaining workloads show a status of “not applicable,” or “N/A,” because as described next, those workloads are waiting in a workload queue (e.g., workload queue 200) for allocation of resources, possibly including accelerator resources.

Column 602f indicates, for those workloads 120 that are waiting in a workload queue for pending workloads (e.g., workload queue 200), the workload queue position of the workload. In this example, workloads 12 (row 604b), 19 (row 604c), 31 (row 604e), and 43 (row 604f) show workload queue positions 3, 1, 7, and 2, respectively. Workloads 5 (row 604a) and 28 (row 604d) show a status of “N/A” because as described previously, workloads 5 and 28 are running and are not waiting in the pending workload queue.

Column 602g indicates, for those workloads 120 that have been allocated accelerator resources, one or more identifiers of the accelerator resources that have been allocated to the workload 120. In this example, workloads 5 (row 604a) and 28 (row 604d) are running (see column 602e) and have been allocated accelerator resources identified by respective AR IDs. The remaining workloads show “N/A” because as described previously, those workloads are waiting in a workload queue (e.g., workload queue 200) for allocation of resources, possibly including accelerator resources.

Column 602h indicates a start time for those workloads 120 that are running. In this example, workloads 5 (row 604a) and 28 (row 604d) are running (see column 602e) and have start times indicated as Time 1 and Time 2, respectively. The remaining workloads show a start times of “N/A” because as described previously, those workloads are waiting in a workload queue (e.g., workload queue 200) for allocation of resources, possibly including accelerator resources. The start time indicated in column 602h may be useful in evaluating whether the toleration time period (e.g., toleration time period 214 of FIG. 2) has expired such that workloads 5 and 28 should be evaluated for possibly satisfying the idleness condition.

Column 602i indicates a priority level (abbreviated as PL) assigned to the workload 120. In the illustrated example, three priority levels (1, 2, and 3) for the workloads 120 that are included in workload information table 600, and each workload 120 is shown to include only one priority level. As described elsewhere, priority levels could be associated with the categories with which a workload 120 is associated, and a workload 120 could be associated with more than one priority level.

Column 602j indicates the idleness threshold (idleness threshold 210 of FIG. 2) that applies for each workload 120. In the illustrated example, each of the workloads 120 has an idleness threshold of zero.

Although not shown additional information for workload information table 600 could include an idle time threshold (e.g., idle time threshold 212) and/or the toleration time period 214 that applies to the workloads 120. Because these parameters can vary from workload to workload in certain implementations, it may be useful to store those values in association with workloads 120 (e.g., in workload information table 600) so that the applicable parameter values can be determined and used.

FIG. 7 illustrates an example user interface 700, according to certain implementations. In certain implementations, user interface 700 may be an example of at least one interface generated by management interface 136 of FIG. 1 to manage scheduler node 104. Management interface 136 and/or scheduler node 104 may generate user interface 700 using workload information 132 and/or accelerator usage information 134. The particular design, layout, and content of user interface 700 are provided as examples only.

In the illustrated example, user interface 700 is arranged by category. For example, a user may specify that user interface 700 is to be displayed according to a particular category by selecting the category from drop-down menu 702. In this example, the category “Frameworks” has been selected, and the information in user interface 700 is arranged according to the Frameworks category.

In the illustrated example, for the different frameworks, user interface 700 includes information indicating the number of accelerators assigned, the status, the priority level, the idleness threshold, the idle time threshold, and an Action column. In certain implementations, user interface 700 provides an ability to modify one or more parameters (e.g., reclamation parameters 208 of FIG. 2) via the gear icon shown in the Action column. Additionally, because user interface is arranged according to a category (e.g., the Frameworks category), a user may be able to modify the one or more parameters (e.g., reclamation parameters 208 of FIG. 2) across all or a portion of the category via user interface 700. For example, the user may be able to change the priority level (priority level in column 602i), idleness threshold (idleness threshold 210 of FIG. 2 and/or in column 602j of FIG. 6), and/or idle time threshold (idle time threshold 212 of FIG. 2) across an entire category of workloads.

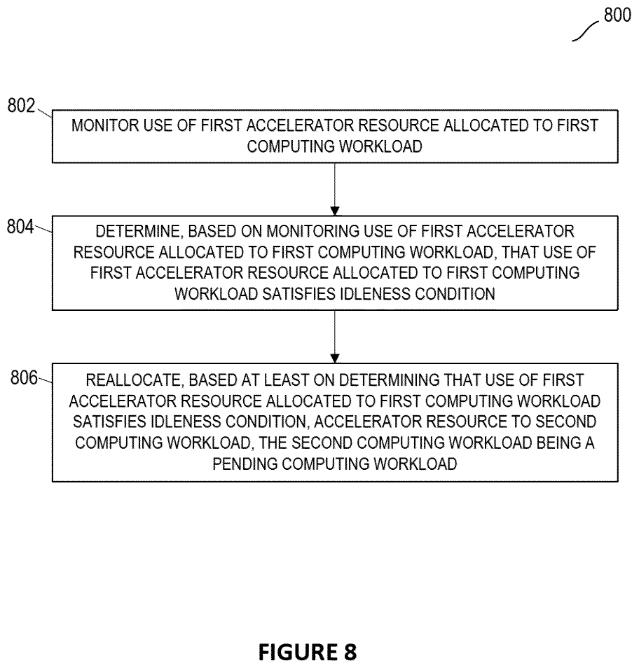

FIGS. 8-10 illustrate various example methods according to certain implementations of this disclosure. In certain implementations, some or all operations associated with the methods of FIGS. 8-10 are performed by scheduler node 104. For example, some or all operations associated with the methods of FIGS. 8-10 may be performed by scheduler node 104. For example, some or all operations associated with the methods of FIGS. 8-10 may be performed by scheduler 202 (including scheduler 202a and/or 202b), scheduler logic 204, and/or reclamation logic 206. Furthermore, the methods of FIGS. 8-10 are described using the examples of the preceding figures, but this disclosure is not limited to such implementations.

For the method described with reference to FIGS. 8-10, it will be assumed that any reclaimed accelerator resources are sufficient for processing any pending workload 120. In certain implementations, it may be appropriate for scheduler node 104 to consider the adequacy of a reclaimed accelerator resource when determining which pending workload 120 will be allocated the reclaimed accelerator resource, as described in greater detail above with reference to FIG. 1. Additionally, as described above, accelerator resources may include one or more accelerators 114 and, for each of the one or more accelerators 114, a portion or all of the processing capability of the accelerator 114. The accelerator resources may include one or more physical accelerator and/or one or more virtual accelerators. In certain implementations, allocating accelerator resources to a workload 120 reserves those accelerator resources for that workload 120.

FIG. 8 illustrates an example method 800 for managing accelerator resources, according to certain implementations. Method 800 may be referred to as a reclamation process, and may be configured to automatically and dynamically reclaim accelerator resources from a workload and reassign those reclaimed accelerator resources to a pending workload. In certain implementations, method 800 may be implemented as part of a scheduler or scheduler plugin, and may be run as a cron job. Example steps of method 800 are described below.

At step 802, scheduler node 104 may monitor use of a first accelerator resource allocated to a first workload 120, which also may be referred to as a computing workload. The first workload 120 may be a workload 120 that is running, including having been allocated the first accelerator resource. In certain implementations, the first workload 120 may be one of multiple workloads 120, and scheduler node 104 may monitor the use of accelerator resources allocated to respective workloads 120 of the multiple running workloads 120. In certain implementations, monitoring the use of accelerator resources allocated to workloads 120 may include scheduler node 104 receiving accelerator usage information 134 from accelerator resources (e.g., from accelerators 114).

At step 804, scheduler node 104 may determine, based on monitoring the use of the first accelerator resource allocated to the first computing workload 120, that the use of the first accelerator resource allocated to the first computing workload 120 satisfies an idleness condition. This disclosure contemplates determining whether use of accelerator resources satisfies an idleness condition in any suitable manner, and various options are described throughout this disclosure.

In certain implementations, determining whether use of an accelerator resource assigned to a running workload 120 satisfies the idleness condition may include scheduler node 104 determining whether the use of the accelerator resource satisfies and idleness threshold. For example, scheduler node 104 may determine, based on monitoring the use of the accelerator resources allocated to workloads 120, that the use of the first accelerator resource allocated to the first workload 120 satisfies an idleness condition by determining that the use of the first accelerator resource does not satisfy an idleness threshold (e.g., idleness threshold 210 of FIG. 2). The idleness threshold may have any suitable value, and in certain implementations may be expressed as a percentage. In a particular example, the idleness threshold has a value of 0. Furthermore, as described previously, an idle time threshold (e.g., idle time threshold 212) may be included as part of the idleness condition. In certain implementations, the idleness condition considers average accelerator utilization over a time period.

In certain implementations, determining that the use of the first accelerator resource does not satisfy the idleness threshold may include scheduler node 104 accessing accelerator usage information 134 for the first accelerator resource and determining, according to accelerator usage information 134 for the first accelerator resource, whether average accelerator usage over a time period (e.g., idle time threshold 212) satisfies the idleness threshold (e.g., idleness threshold 210). Based at least on determining that the average accelerator usage for the first accelerator resource over the time period does not satisfy the idleness threshold (e.g., is not greater than the idleness threshold), scheduler node 104 may determine that the use of the first accelerator resource allocated to the first workload 120 satisfies an idleness condition and should be considered idle.

As described above with reference to step 802, scheduler node 104 may be monitoring the use of accelerator resources by multiple running workloads 120 (with respect allocations of one or more accelerator resources). Scheduler node 104 may be evaluating some or all of those other running workloads to determine whether those computing workloads satisfy the idleness condition. For example, prior to and/or after determining at step 804 that the use of the first accelerator resource allocated to the first computing workload 120 satisfies the idleness condition, scheduler node 104 may determine that the use of one or more other accelerator resources by one or more other workloads 120 do or do not satisfy the idleness condition.

At step 806, scheduler node 104 may reallocate, based at least on determining that the use of the first accelerator resource allocated to the first computing workload 120 satisfies the idleness condition, the first accelerator resource to a second workload 120. The second workload 120 may be a pending workload 120, and could be stored in a pending workload queue (e.g., workload queue 200).

In some implementations, the second workload 120 is one of multiple pending workloads 120. Scheduler node 104 may use any suitable technique to determine which pending workload 120 will be allocated the first accelerator resource that is being reclaimed from the first computing workload 120. For example, scheduler node 120 simply choose the next pending workload from the pending workload queue (e.g., workload queue 200) as the second workload 120 to be allocate the first accelerator resource that is being reclaimed from the first computing workload 120. As another example, scheduler node 104 may consider relative priorities of pending workloads 120 when determining which pending workload 120 will be allocated the first accelerator resource that is being reclaimed from the first computing workload 120.

For the priority consideration approach, in certain implementations, scheduler node 104 may access a pending workload queue (e.g., workload queue 200) that includes multiple pending workloads 120 and obtain prioritization information for the pending workloads 120 in the pending workload queue. The prioritization information could be obtained from workload information 132, the workloads 120 themselves, and/or any other suitable source. Scheduler node 104 may determine a selected pending workload 120 to be the second computing workload 120 according to the respective priorities of the pending workloads 120. As described in greater detail elsewhere in this description, in certain implementations, a priority identified by the prioritization information corresponds to a category for the workload 120.

In certain implementations reallocating the reclaimed accelerator resource to a second workload 120 may include deallocating the accelerator resource from the first workload 120. The first workload 120 from which the accelerator resource has been reclaimed can be handled in any suitable manner. In certain implementations, scheduler node 104 may transition, in response to reallocating the accelerator resource to a second workload 120, the first workload 120 to a pending state, which may include placing the first workload 120 in a pending workload queue, eligible to be assigned accelerator resources along with other pending computing workloads 120 according to applicable scheduling policies. This approach may be referred to as non-destructive preemption, as this approach moves computing workloads 120 from which accelerator resources have been reclaimed to a pending state rather than terminating those computing workloads 120. Of course, this disclosure contemplates simply terminating those computing workloads 120 or handling them in some other manner, if appropriate.

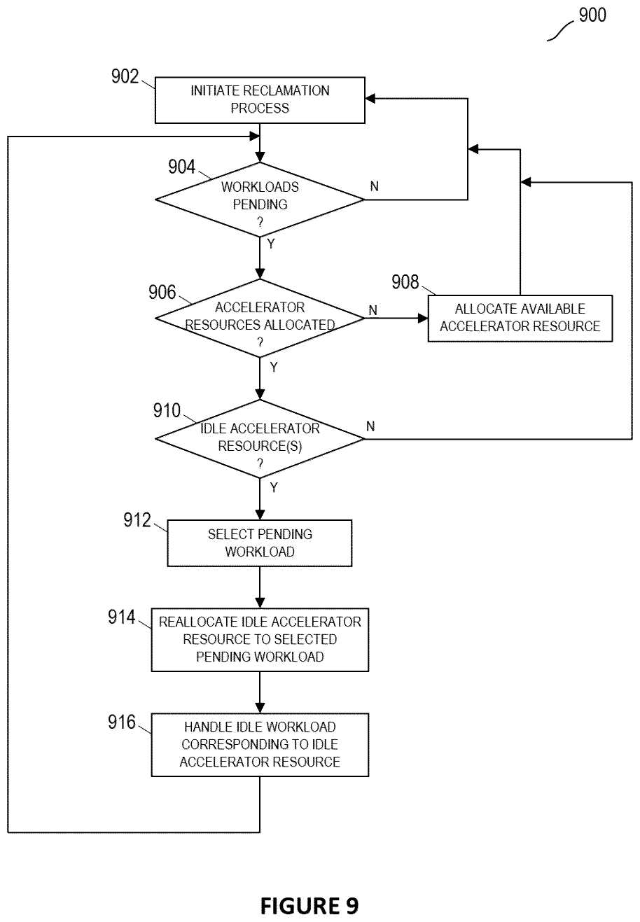

FIG. 9 illustrates an example method 900 for managing accelerator resources, according to certain implementations. At step 902, the reclamation process for determining whether to reclaim and reallocate accelerator resources from running workloads may be initiated. In certain implementations, as described above, this reclamation process may be a cron job or other suitable type of program that scheduler node 104 runs at regular or irregular intervals, or in response to particular events

At step 904, scheduler node 104 may determine whether any workloads 120 are pending. A pending workload 120 may be a workload 120 that is waiting for resources, which may include one or more accelerator resources, to become available for allocation to the pending workload 120. Pending workloads 120 may be stored in a workload queue (e.g., workload queue 200 of FIGS. 2 and 5). In certain implementations, scheduler node 104 may access workload queue 200 to determine whether any pending workloads 120 are present.

If scheduler node 104 determines at step 904 that there are no pending workloads 120, then the reclamation process may terminate and return to step 902 to restart at the appropriate time and/or in response to a suitable event. If, on the other hand, scheduler node 104 determines at step 904 that one or more workloads 120 are pending, then method 900 may proceed to step 906.

At step 906, scheduler node 104 may determine whether all accelerator resources have been allocated. In other words, scheduler node 104 may determine whether any accelerator resources are available to the pending workloads 120 identified at step 904. If scheduler node 104 determines at step 906 that not all accelerator resources have been allocated (that accelerator resources are available for allocation), then method 900 may proceed to step 908. At step 908, scheduler node 104 may allocate available accelerator resources to pending workloads 120. If, on the other hand, scheduler node 104 determines at step 906 that all accelerator resources have been allocated (that accelerator resources are not available for allocation to pending workloads 120), then method 900 may proceed to step 910.

At step 910, scheduler node 104 determine whether any accelerator resources that have been allocated to running workloads 120 are idle. In other words, at step 910, scheduler node 104 may attempt to identify idle allocated accelerator resources for reclamation. As described above, scheduler node 104 may determine whether the use of accelerator resources that have been allocated to running workloads satisfy an idleness condition. In certain implementations, scheduler node 104 determine whether any accelerator resources that have been allocated to running workloads 120 are idle using one or more of accelerator usage information 134, an idleness threshold 210, and idle time threshold 212. Various techniques for determining whether accelerator resources are idle are described throughout this disclosure.

If scheduler node 104 determines at step 910 that there no idle accelerator resources exist, then the reclamation process may terminate and return to step 902 to restart at the appropriate time and/or in response to a suitable event. If, on the other hand, scheduler node 104 determines at step 910 that idle allocated accelerator resources exist, then method 900 may proceed to step 912.

At step 912, scheduler node 104 may select one or more pending workloads 120 that will be allocated the idle resources identified at step 910. Various techniques for selecting pending workloads 120 to receive idle accelerator resources are described throughout this disclosure. Factors may include position in pending workload queue 200 (which also may reflect the relative lengths of time workloads 120 have been pending), priorities of pending workloads 120, and any other suitable factors.

At step 914, scheduler node 104 may reallocate one or more accelerator resources that were identified as idle (e.g., at step 910) to one or more pending workloads 120 that were selected at step 912.

At step 916, scheduler 104 may handle workloads 120 from which idle accelerator resources were reclaimed. The workload 120 from which idle accelerator resources are being reclaimed (e.g., are being deallocated) can be handled in any suitable manner. In certain implementations, the workloads 120 may be placed in a pending workload queue (e.g., workload queue 200 of FIGS. 2 and 5), eligible to be assigned accelerator resources along with other pending workloads 120 according to applicable scheduling policies. This approach may be referred to as non-destructive preemption, as this approach moves workloads 120 from which accelerator resources have been reclaimed to a pending state rather than terminating those workloads 120. This disclosure also contemplates simply terminating those workloads 120 from which accelerator resources have been reclaimed or handling those workloads 120 in some other manner, if appropriate.

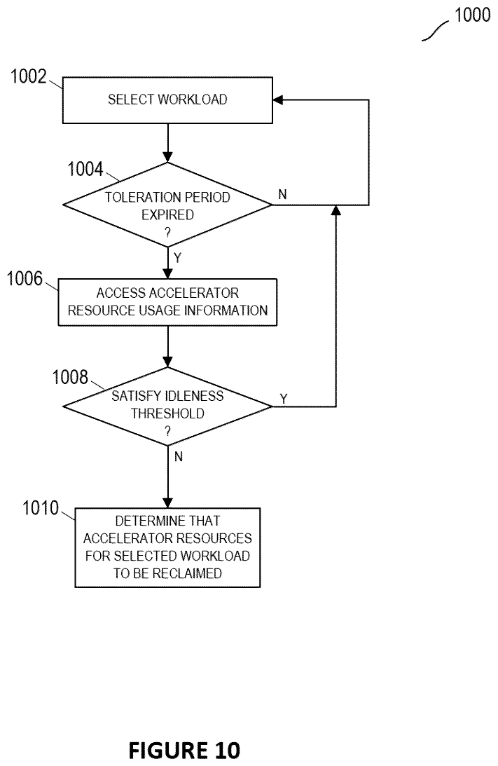

FIG. 10 illustrates an example method 1000 for determining whether to reclaim accelerator resources that have been allocated to a particular workload 120, according to certain implementations. As just one example, method 1000 may provide a particular technique for performing some or all of step 804 of method 800 of FIG. 8 and/or step 910 of method 900 of FIG. 9. In particular, method 1000 provides a technique to traverse through running workloads 120 to identify running workloads 120 that are idle with respect to the accelerator resources that have been allocated to those running workloads 120 such that those allocated accelerator resources are idle and could be reallocated to other pending workloads 120. For purposes of this example, it will be assumed that the idleness condition to be evaluated by scheduler node 104 includes an idleness threshold (e.g., idleness threshold 210 of FIGS. 2 and/or 602j of FIG. 6).

At step 1002, scheduler node 104 may select a running workload 120 to analyze. In certain implementations, scheduler node 104 may determine the running workloads that have been assigned accelerator resources using workload information 132 (see FIG. 1), an example of which is shown in workload information table 600 of FIG. 6.

At step 1004, scheduler node 104 may determine whether a toleration period for the running workload 120 selected at step 1002 has expired.

If scheduler node 104 determines at step 1004 that the toleration period for the running workload 120 selected at step 1002 has not expired, then, method 1000 may return to step 1002 for scheduler node 104 to select a next running workload to evaluate. If however, scheduler node 104 determines at step 1004 that the toleration period for the running workload 120 selected at step 1002 has expired, then method 1000 may proceed to step 1006.

At step 1006, scheduler node 104 may access accelerator resource usage information (e.g., accelerator usage information 134 in FIG. 1) for the one or more accelerator resources that are allocated to the running workload 120 selected at step 1002. In certain implementations, the accelerator usage information may indicate whether the running workload 120 selected at step 1002 has been using the one or more accelerator resources. As a particular example, the accelerator usage information may either specify, or may provide scheduler node 104 with sufficient information to determine, average accelerator usage information for the one or more accelerator resources, indicating the average use of those accelerator resources by the selected running workload 120 over a particular time period. The particular time period could be an idle time threshold (e.g., idle time threshold 212 of FIG. 2).

At step 1008, scheduler node 104 may determine, according to the accelerator resource usage information accessed at step 1006, whether the usage of the one or more accelerator resources by the selected running workload 120 satisfies the idleness threshold. For example, scheduler node 104 may determine whether the average accelerator usage over a time period (e.g., the idle time threshold) satisfies the idleness threshold.

As described above, the idleness threshold may be adjusted to set different sensitivities to idle acceleration resources. For example, an idleness threshold defined as zero essentially enforces a condition in which a particular workload 120 may satisfy the idleness condition by making at least some use of the one or more accelerator resources over the particular time period. As another example, an idleness threshold defined as twenty percent may enforce a condition in which a particular workload 120 may satisfy the idleness condition by using the one or more accelerator resources at least twenty percent of the time over the particular time period.

If scheduler node 104 determines at step 1008 that the usage of the one or more accelerator resources by the selected running workload 120 satisfies the idleness threshold, then method 1000 may return to step 1002 for scheduler node 104 to select a next running workload 120 to evaluate. If, on the other hand, scheduler node 104 determines at step 1008 that the usage of the one or more accelerator resources by the selected running workload 120 do not satisfy the idleness threshold, then method 1000 may proceed to step 1010. At step 1010, based on the determination at step 1008, scheduler node 104 may determine that the one or more accelerator resources allocated to the selected running workload 120 are to be reclaimed from the selected running workload 120 and reallocated to a pending workload 120.

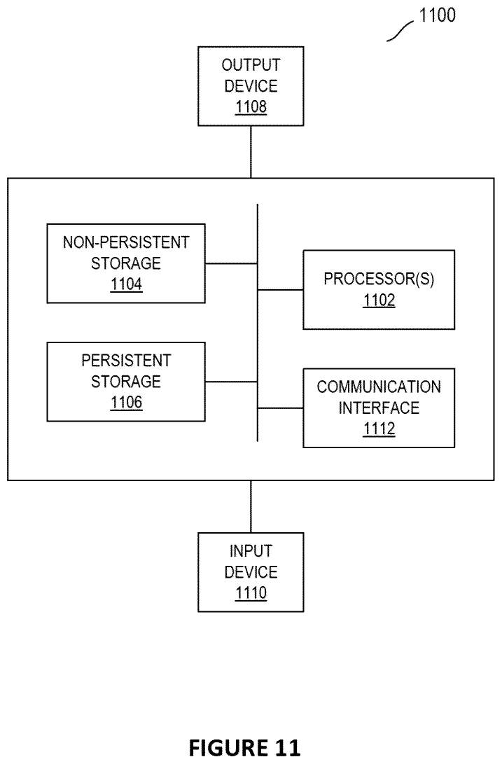

FIG. 11 illustrates a block diagram of an example computing device 1100, according to certain implementations. As discussed above, implementations of this disclosure may be implemented using computing devices. For example, all or any portion of the components or methods shown in FIGS. 1-10 (e.g., computing system 100, compute nodes 102, scheduler node 104, scheduler 202 (including scheduler 202a and/or scheduler 202b), and methods 800 through 1000) may be implemented, at least in part, using one or more computing devices such as computing device 1100.

Computing device 1100 may include one or more computer processors 1102, non-persistent storage 1104 (e.g., volatile memory, such as RAM, cache memory, etc.), persistent storage 1106 (e.g., a hard disk, an optical drive such as a compact disk (CD) drive or digital versatile disk (DVD) drive, a flash memory, etc.), a communication interface 1112 (e.g., Bluetooth interface, infrared interface, network interface, optical interface, etc.), input devices 1110, output devices 1108, and numerous other elements and functionalities. Each of these components is described below.

In certain implementations, computer processor(s) 1102 may be an integrated circuit for processing instructions. For example, computer processor(s) may be one or more cores or micro-cores of a processor. Processor 1102 may be a general-purpose processor configured to execute program code included in software executing on computing device 1100. Processor 1102 may be a special purpose processor where certain instructions are incorporated into the processor design. Although only one processor 1102 is shown in FIG. 11, computing device 1100 may include any number of processors.

Computing device 1100 may also include one or more input devices 1110, such as a touchscreen, keyboard, mouse, microphone, touchpad, electronic pen, motion sensor, or any other type of input device. Input devices 1110 may allow a user to interact with computing device 1100. In certain implementations, computing device 1100 may include one or more output devices 1108, such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to computer processor(s) 1102, non-persistent storage 1104, and persistent storage 1106. Many different types of computing devices exist, and the aforementioned input and output device(s) may take other forms. In some instances, multimodal systems can allow a user to provide multiple types of input/output to communicate with computing device 1100.

Further, communication interface 1112 may facilitate connecting computing device 1100 to a network (e.g., a LAN, WAN) such as the Internet, mobile network, or any other type of network) and/or to another device, such as another computing device. Communication interface 1112 may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a Bluetooth® Low Energy (BLE) wireless signal transfer, an IBEACON® wireless signal transfer, a radio frequency identifier (RFID) wireless signal transfer, near-field communications (NFC) wireless signal transfer, dedicated short range communication (DSRC) wireless signal transfer, 802.11 Wi-Fi wireless signal transfer, WLAN signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1112 may also include one or more Global Navigation Satellite System (GNSS) receivers or transceivers that are used to determine a location of the computing device 1100 based on receipt of one or more signals from one or more satellites associated with one or more GNSS systems. GNSS systems include, but are not limited to, the US-based global positioning system (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

The term computer-readable medium includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

All or any portion of the components of computing device 1100 may be implemented in circuitry. For example, the components can include and/or be implemented using electronic circuits or other electronic hardware, which can include one or more programmable electronic circuits (e.g., microprocessors, graphics processing units (GPUs), digital signal processors (DSPs), CPUs, and/or other suitable electronic circuits), and/or can include and/or be implemented using computer software, firmware, or any combination thereof, to perform the various described operations. In some aspects the computer-readable storage devices, mediums, and memories can include a cable or wireless signal containing a bit stream and the like.

It should be understood that the systems and methods described in this disclosure may be combined in any suitable manner.

Certain implementations of this disclosure may provide some, none, or all of the following technical advantages. Certain implementations may improve accelerator utilization for computer systems. For example, certain implementations may improve accelerator utilization by identifying idle accelerator resources and reallocating those idle accelerator resources to pending computing workloads, which may provide dynamic and intelligent resource allocation. For example, certain implementations dynamically adjust accelerator resource allocation based on usage patterns. Detecting when an accelerator resource is underutilized and reallocating that accelerator resources to a pending computing workload that awaits an accelerator resource may improve overall system efficiency. Furthermore, such an approach may improve a user's experience. For example, by efficiently managing accelerator resources, certain implementations may reduce wait times for users seeking accelerator resource access, which may lead to improved productivity and user satisfaction.

Certain implementations may provide priority-based scheduling, such as allowing reclamation of accelerator resources according to relative priorities of computing workloads, potentially allowing fine-grained control over resource allocation based on configurable priorities. This approach may facilitate high-priority computing workloads or critical projects obtaining access to accelerator resources when appropriate, even if doing so means preempting a lower-priority, idle computing workload.

Certain implementations allow a user (e.g., an IT administrator) to configure and adjust (e.g., via a user interface) priorities of computing workloads and/or one or more idleness thresholds (e.g., a time threshold, a usage threshold, etc.) for determining whether an accelerator is idle. This configuration capability may allow the sharing of accelerator resources in a manner that achieves particular goals of an organization-goals that might change over time or at different time periods.

Certain implementations allow for non-destructive preemption of computing workloads. For example, if a computing workload is preempted, meaning that an accelerator resource is reallocated to another computing workload, then the preempted computing workload may be moved to a pending state rather than terminated. This may allow the preempted computing workload to resume when accelerator (or other) resources become available again, potentially preserving work and improving user experience.

Certain implementations, provide seamless integration with KUBERNETES and/or other containerization platforms. For example, certain implementations are designed to work alongside KUBERNETES (or other containerization) components, potentially making the solution easy to adopt without significant changes to the overall infrastructure. Certain implementations can be deployed as a plugin to the default scheduler of the containerization platform, focusing on accelerator computing workloads. Certain implementations may support for both physical and virtual accelerators, such as both physical and virtual GPUs, which may provide a versatile for different types of deployments and virtualization strategies.

Certain implementations may enhance return on investment for accelerator hardware, such as by reducing or eliminating instances of expensive accelerator resources sitting idle while other computing workloads are waiting in queue. In certain implementations, more efficient use of existing accelerator resources may lead to cost savings by reducing or eliminating additional purchases of accelerator hardware to meet demand.

Although this disclosure describes or illustrates particular operations as occurring in a particular order, this disclosure contemplates the operations occurring in any suitable order. Moreover, this disclosure contemplates any suitable operations being repeated one or more times in any suitable order. Although this disclosure describes or illustrates particular operations as occurring in sequence, this disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. The acts can operate in an operating system environment or as stand-alone routines occupying all or a substantial part of the system processing.

While this disclosure has been described with reference to illustrative implementations, this description is not intended to be construed in a limiting sense. Various modifications and combinations of the illustrative implementations, as well as other implementations of the disclosure, will be apparent to persons skilled in the art upon reference to the description. It is therefore intended that the appended claims encompass any such modifications or implementations.

What is claimed is:

1. A computing device, comprising:
one or more processors; and
one or more non-transitory computer-readable storage media storing programming for execution by the one or more processors, the programming comprising instructions to:
monitor use of a first accelerator resource allocated to a first computing workload;
determine, based on monitoring the use of the first accelerator resource allocated to the first computing workload, that the use of the first accelerator resource allocated to the first computing workload satisfies an idleness condition; and
reallocate, based at least on determining that the use of the first accelerator resource allocated to the first computing workload satisfies the idleness condition, the first accelerator resource to a second computing workload, the second computing workload being a pending computing workload.

2. The computing device of claim 1, wherein:
the first workload comprises first workload information that comprises:
a category associated with the first workload;
a priority associated with the first workload; and
a start time associated with the first workload; and
the second workload comprises second workload information that comprises:
a category associated with the second workload; and
a priority associated with the second workload.

3. The computing device of claim 1, wherein the instructions to determine that the use of the first accelerator resource allocated to the first computing workload satisfies an idleness condition comprise instructions to determine that the use of the first accelerator resource does not satisfy an idleness threshold.

4. The computing device of claim 3, wherein the instructions to determine that the use of the first accelerator resource does not satisfy the idleness threshold comprise instructions to:
access accelerator usage information for the first accelerator resource;
determine, according to the accelerator usage information, whether average accelerator usage over a time period satisfies an idleness threshold; and
determine, based at least on determining that the average accelerator usage over a time period does not satisfy the idleness threshold, that the use of the first accelerator resource allocated to the first computing workload satisfies an idleness condition.

5. The computing device of claim 4, wherein the idleness threshold is zero.

6. The computing device of claim 1, wherein the instructions to monitor use of the first accelerator resource allocated to the first running computing workload comprise instructions to receive accelerator usage information from the first accelerator resource.

7. The computing device of claim 1, wherein the programming further comprises instructions to determine, prior to reallocating the accelerator resource to the second computing workload, that the first workload has been running for a toleration time period.

8. The computing device of claim 1, wherein:
the second computing workload is one of a plurality of pending computing workloads; and
the programming further comprises instructions to:
access a pending workload queue that comprises the plurality of pending computing workloads;
obtain prioritization information for the plurality of pending computing workloads; and
determine a selected pending workload to be the second computing workload according to respective priorities of the plurality of pending computing workloads.

9. The computing device of claim 8, wherein a priority identified by the prioritization information corresponds to a category for the computing workload.

10. The computing device of claim 1, wherein:
reallocating the accelerator resource to a second computing workload comprises deallocating the accelerator resource from the first computing workload; and
the programming further comprises instructions to transition, in response to reallocating the accelerator resource to a second computing workload, the first computing workload to a pending state.

11. The computing device of claim 1, wherein the first accelerator resource is a graphics processing unit (GPU) or a portion of a GPU.

12. The computing device of claim 1, wherein:
the second computing workload comprises one or more containers; and
the accelerator resource operates in a containerization environment.

13. A computer-implemented method, comprising:
monitoring, by a computing device, use of a first accelerator resource allocated to a first computing workload;
determining, by the computing device and based on monitoring the use of the first accelerator resource allocated to the first computing workload, that the use of the first accelerator resource allocated to the first computing workload satisfies an idleness condition; and
reallocating, by the computing device and based at least on determining that the use of the first accelerator resource allocated to the first computing workload satisfies the idleness condition, the first accelerator resource to a second computing workload, the second computing workload being a pending computing workload.

14. The computer-implemented method of claim 13, comprising:
monitoring use of a plurality of accelerator resources allocated to respective computing workloads of a plurality of running computing workloads, the first computing workload being one of the plurality of running computing workloads, the respective accelerator resource for the first computing workload comprising the first accelerator resource;
determining, prior to determining that the use of the first accelerator resource allocated to the first computing workload satisfies the idleness condition, that the use of a second accelerator resource of the plurality of accelerator resources by a third workload of the plurality of running workloads does not satisfy the idleness condition.

15. The computer-implemented method of claim 13, wherein determining that the use of the first accelerator resource allocated to the first computing workload satisfies an idleness condition comprise determining that the use of the first accelerator resource does not satisfy an idleness threshold.

16. The computer-implemented method of claim 15, wherein determining that the use of the first accelerator resource does not satisfy the idleness threshold comprises:
accessing accelerator usage information for the first accelerator resource;
determining, according to the accelerator usage information, whether average accelerator usage over a time period satisfies an idleness threshold; and
determining, based at least on determining that the average accelerator usage over a time period does not satisfy the idleness threshold, that the use of the first accelerator resource allocated to the first computing workload satisfies an idleness condition.

17. The computer-implemented method of claim 13, wherein monitoring use of the first accelerator resource allocated to the first running computing workload comprises receiving accelerator utilization information from the first accelerator resource.

18. The computer-implemented method of claim 13, wherein:
the second computing workload is one of a plurality of pending computing workloads; and
the method further comprises:
accessing a pending workload queue that comprises the plurality of pending computing workloads;
obtaining prioritization information for the plurality of pending computing workloads; and
determining a selected pending workload to be the second computing workload according to respective priorities of the plurality of pending computing workloads.

19. The computer-implemented method of claim 13, wherein:
reallocating the accelerator resource to a second computing workload comprises deallocating the accelerator resource from the first computing workload; and
the method further comprises transitioning, in response to reallocating the accelerator resource to a second computing workload, the first computing workload to a pending state.

20. One or more non-transitory computer-readable storage media storing programming for execution by the one or more processors, the programming comprising instructions to:
monitor use of a first accelerator resource allocated to a first computing workload;
determine, based on monitoring the use of the first accelerator resource allocated to the first computing workload, that the use of the first accelerator resource allocated to the first computing workload satisfies an idleness condition; and
reallocate, based at least on determining that the use of the first accelerator resource allocated to the first computing workload satisfies the idleness condition, the first accelerator resource to a second computing workload, the second computing workload being a pending computing workload.
